(19) United States
(12) Patent Application Publication
(10) Pub. No.: US 2006/0178150 A1
(43) Pub. Date: Aug. 10, 2006

(54) Method of transmitting data with minimum energy consumption in a wireless sensor network

(75) Inventor: Hyung-Seok Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/348,497

(22) Filed: Feb. 6, 2006

(30) Foreign Application Priority Data
Feb. 4, 2005 (KR) 10-2005-0010354

(51) Int. Cl. G06F 15/16; H04Q 7/20

(52) U.S. Cl. 455/445; 709/252

(57) ABSTRACT

Disclosed is a method of configuring a tree when a new sink is added in a wireless sensor network. The method includes selecting a first sensor node via which a path can run to a new sink with the smallest delay cost, if the new sink requesting the sensed information as a sink within an existing tree is added; thereafter determining whether a path connecting the first sensor node directly(direct path) to the new sink has minimal energy consumption, after selecting the first sensor node. A second sensor node via which a path can run to the new sink with the minimal energy consumption, if the direct path does not have the minimal energy consumption. Therefore, an optimal tree having the minimal energy consumption can be configured.

### PRIORITY

This application claims priority under 35 U.S.C. §119 to an application entitled “Method of Transmitting Data with Minimum Energy Consumption in a Wireless Sensor Network” filed in the Korean Intellectual Property Office on Feb. 4, 2005 and assigned Serial No. 2005-10354, the contents of which are incorporated herein by reference.

### BACKGROUND OF THE INVENTION

1. Field of the Invention

The present invention relates generally to a method of transmitting data with minimum energy consumption in a wireless sensor network, and in particular, to a method of determining paths for routing information to a plurality of destinations (i.e. sinks) while minimizing energy consumption in a wireless sensor network.

2. Description of the Related Art

In a wireless sensor network, hundreds of or thousands of sensor nodes are scattered over a wide area, to monitor events occurring in the surrounding environments and to provide collected information to a remote information collector. The wireless sensor networks are used in military, natural environment measuring, and emergency monitoring applications. The sensor nodes play a dual role as both routers and data generators. These sensor nodes are powered by limited unchargeable batteries.

The wireless sensor network transfers information generated from a sensor node being a data source to a remote information collector requesting the information by multiple hops. Transmission of information to an information collector over multiple hops is called data dissemination.

Conventional techniques for efficient data dissemination in the wireless sensor network include “Two-Tier Data Dissemination (TTDD)” and “Directed Diffusion (DD)”. These techniques will be described below on the assumption that the sensor nodes are aware of their locations. The sensor nodes estimate their locations by collecting and exchanging information from a small number of scattered Global Positioning System (GPS)-enabled sensor nodes.

FIG. 1 is a diagram illustrating a conventional TTDD scheme. Referring to FIG. 1, in TTDD, grid lines are drawn over whole sensor nodes. A sink (destination) 103 (Sink A) sends a request packet 109 to a source 101 along the nodes on grid lines. The source 101 aggregates requested information and sends the aggregated information to Sink A along the nodes on the grid lines, as indicated by the solid lines with arrows. If another sink (destination) 105 (Sink B) requests the same information to the source 101 by sending a request packet, a new dissemination tree is built by adding a dissemination path running to Sink B to an existing data dissemination path.

FIGS. 2A, 2B and 2C are diagrams illustrating a conventional DD scheme. In DD, a sink (destination) 201 sends a request packet to a source 203 from a plurality of paths shown in FIG. 2A. Referring to FIG. 2B, the source 203 sends sensed data in paths from which the request packet has been received and all sensor nodes receiving the sensed data route the data to their neighbor sensor nodes from which they have received the request packet. Referring to FIG. 2C, the sink 201 receives the sensed data from the source 203. If another sink requests the same data to the source 203, it receives the data in the same manner.

A drawback of conventional techniques is that power dissipation increases when adding a new sink which requests the same data as the existing sinks in a dissemination tree.

To be more specific, since TTDD establishes a data dissemination path based on grid lines, a simple path connecting one source to one sink can be up to \sqrt{2} (=1.414) times longer than the linear line between them. The resulting increase in the average number of hops between the sink and the source increases the number of sensor nodes involved and thus increases average power consumption.

In DD, all available paths are monitored to find an optimal path, resulting in large energy consumption. Every time a new sink is added to an existing dissemination tree or an existing sink for which a path has already established is moved/pruned, the procedure illustrated in FIGS. 2A, 2B and 2C is repeated for tree reconfiguration. Therefore, energy consumption is increased.

Multicast algorithms for a multi-hop ad hoc network, such as Ad hoc On demand Distance Vector (AODV) and Clustered Group Multicast (CGM), select optimal paths usually on the premise that a fixed number of sinks exist and each node has knowledge of the other nodes. However, these multicast algorithms are not viable for the wireless sensor network because the sensor nodes with limited resources cannot store information about many other sensor nodes. In addition, in case where sinks sequentially participate in the wireless sensor network, tree reconfiguration at each time leads to path loss or increases power consumption.

### SUMMARY OF THE INVENTION

An object of the present invention is to substantially solve at least the above problems and/or disadvantages and to provide at least the advantages below. Accordingly, an object of the present invention is to provide a method of reducing the total energy consumption of a wireless sensor network.

Another object of the present invention is to provide a method of adding a new sink without tree reconfiguration in a wireless sensor network.

A further object of the present invention is to provide a method of determining an optimal path having minimal energy consumption in case where a new sink is added in a wireless sensor network.

The above objects are achieved by providing a method of configuring a tree when a new sink is added in a wireless sensor network. In the tree configuring method, a first sensor node via which a path can run to a new sink with the smallest delay cost is selected, if the new sink requesting the same sensed information as a sink within an existing tree is added. It is determined whether a path connecting the first sensor node directly to the new sink has minimal energy consumption, after selecting the first sensor node. A second sensor node via which a path can run to the new sink with the minimal energy consumption is selected, if the direct path does not have the minimal energy consumption. Therefore, an optimal tree having the minimal energy consumption is configured.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a conventional TTDD scheme;

FIGS. 2A, 2B and 2C are diagrams illustrating a conventional DD scheme;

FIG. 3 is a diagram illustrating a hierarchical protocol structure for data dissemination according to the present invention;

FIG. 4 is a diagram illustrating a dissemination tree structure in a wireless sensor network according to the present invention;

FIG. 5 is a diagram illustrating routing of a request packet according to the present invention;

FIG. 6 is a diagram illustrating location-aware routing according to the present invention;

FIG. 7 is a diagram illustrating a method of finding an entry relay node and connecting to the entry relay node according to the present invention;

FIG. 8 is a flowchart illustrating a method of determining the entry relay node according to the present invention;

FIG. 9 is a flowchart illustrating a method of establishing paths to sinks after determining the entry relay node according to the present invention;

FIGS. 10A and 10B are diagrams illustrating a method of establishing a direct path from an entry relay node to a sink according to the present invention;

FIGS. 11A and 11B are diagrams illustrating a method of finding a joint relay node and connecting to the joint relay node according to the present invention;

FIG. 12 is a flowchart illustrating a method of determining the joint relay node according to the present invention; and

FIG. 13 is a graph illustrating improved performance of the present invention.

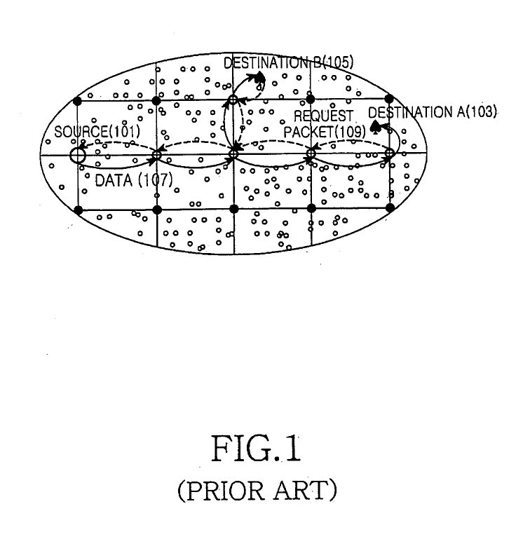

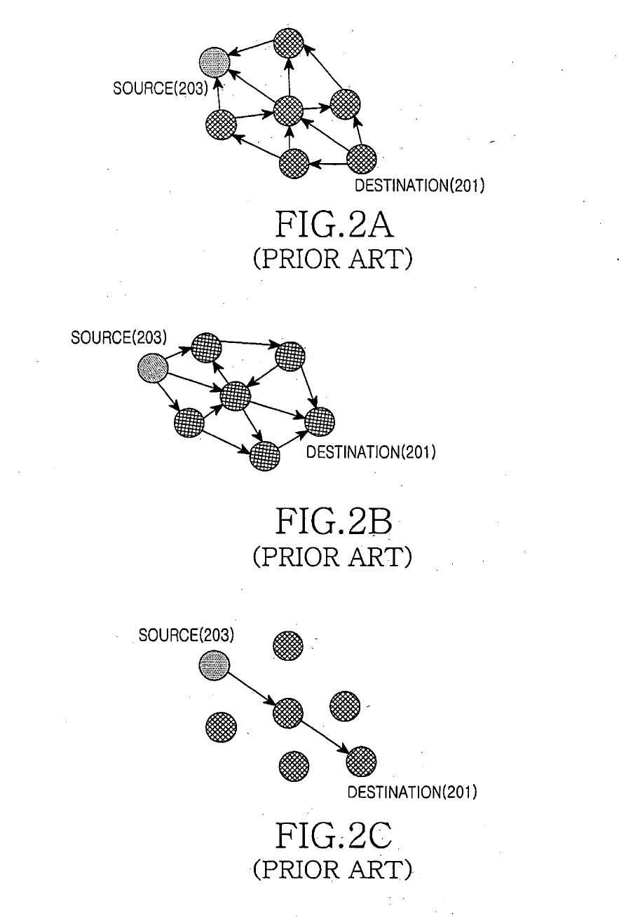

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention is intended to provide a technique for configuring a dissemination tree while conserving energy consumption when a new sink is added to the dissemination tree in a wireless sensor network. If a new sink requests the same sensed information as other existing sinks, an optimal path offering less energy consumption is determined such that the new sink is added to an existing dissemination tree without changing the tree configuration. The dissemination tree refers to the paths linked to existing sinks before the new sink requesting the same sensed information is added. The sensed information may be different as far as time is concerned.

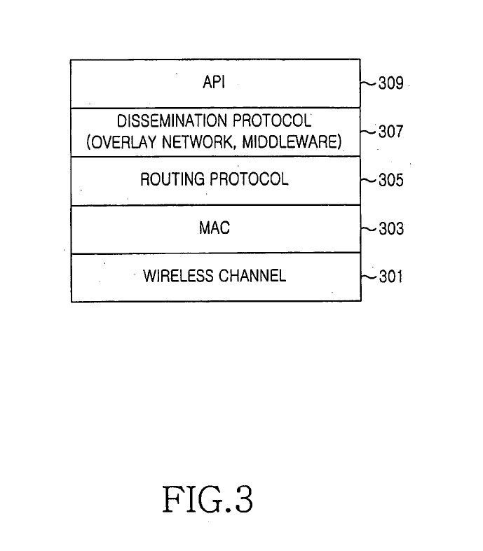

FIG. 3 is a diagram illustrating a hierarchical protocol structure for data dissemination in a wireless sensor network according to the present invention. Referring to FIG. 3, a protocol stack according to the present invention includes a wireless channel 301, a Medium Access Control (MAC) layer 303, a routing protocol layer 305, a dissemination protocol layer 307, and an Application Programming Interface (API) layer 309 in the order of lowest to highest layers. The dissemination protocol 307 is responsible for constructing a tree for data dissemination.

A tree configuration that enables data dissemination while conserving energy consumption in sensor nodes of the wireless sensor network will be described under the following assumption.

Since it is assumed that every sensor node is not aware of all other sensor nodes across the network, it does not know the number of hops to any other sensor node. Thus, the number of hops between two sensor nodes to exchange data packets (e.g. a source 401 and a sink 403) is estimated by the distance between them. This is possible because the sensor nodes are densely distributed over a wide area.

The energy consumption of the sensor nodes in data packet transmission is proportional to the number of hops, the length of data packets, and the data rate of the packets. In the following description, the length and data rate of data packets are assumed to be fixed, to thereby exclude the influence of the length and rate of the data packets on energy consumption. Accordingly, a method of reducing total energy consumption by decreasing the number of hops in data dissemination to a plurality of sinks will now be described.

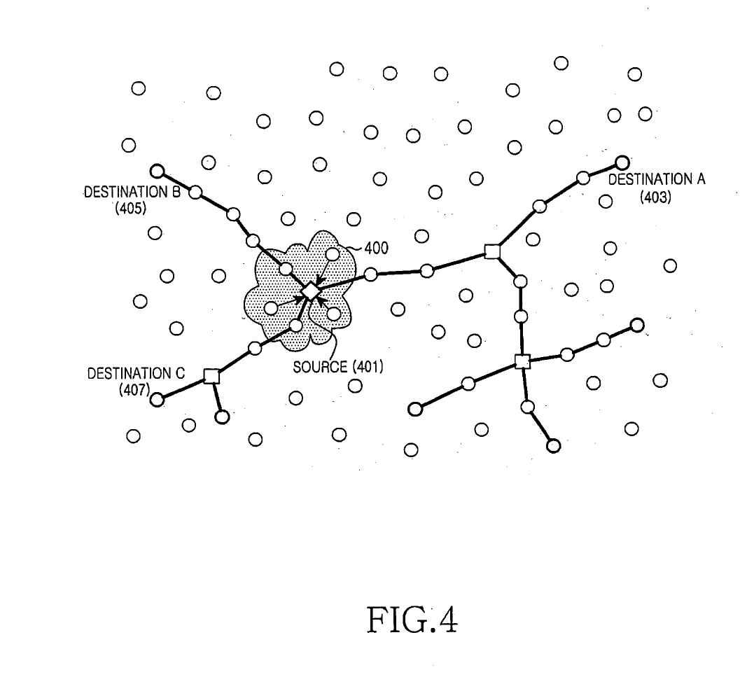

FIG. 4 illustrates a dissemination tree structure in the wireless sensor network according to the present invention. Referring to FIG. 4, a source 401 representative of the sensor nodes of a particular group 400 aggregates sensed data from its group and creates a data packet with the aggregated data. The data packet is routed to a plurality of sinks (i.e., destinations) 403, 405 and 407 (Sink A, Sink B and Sink C, respectively) over a plurality of hops.

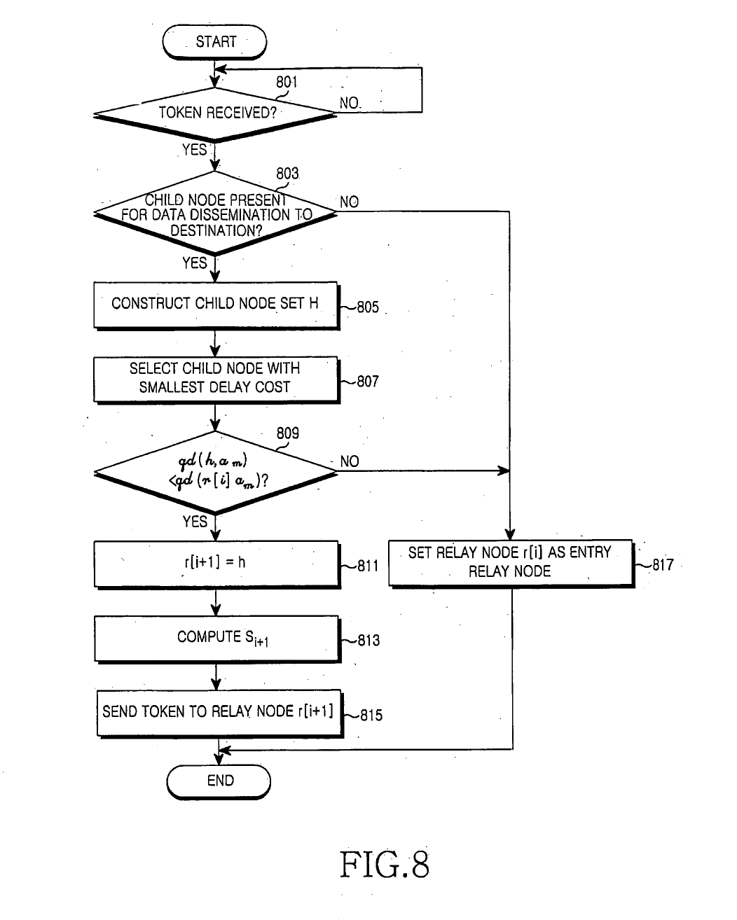

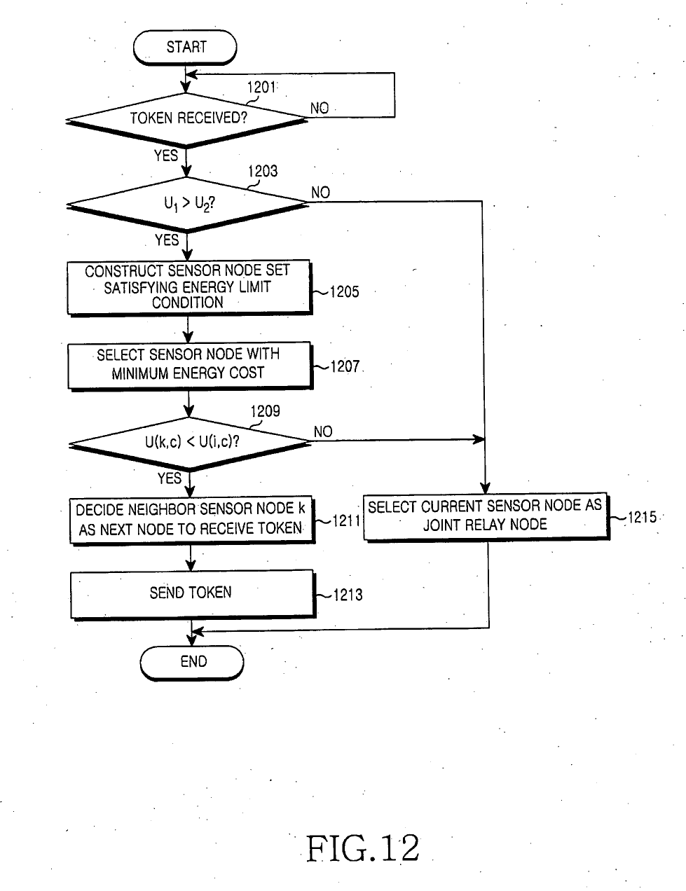

Tree configuration by a dissemination protocol is carried out largely in three steps. In the case where a new sink requesting the same sensed information is added to the sinks 403, 405, and 407 already connected in the tree, the following steps are performed in sequence: (1) The new sink sends a request packet requesting the same sensed information about the particular area 400 to the source 401; (2) The source 401 generates a token to allow the new sink to join the tree and thus to receive the sensed information, and performs a procedure for searching for a relay node to which the sink can be connected most efficiently (for details, see FIG. 8) in the existing tree. The token is a message containing the position information of the new sink and the sum of delay costs for a relay node that has received the token from the source; and 401 (3) After finding the most efficient relay node, a sensor node is detected which provides an optimal path to send the same sensed information to a plurality of sinks with minimal energy consumption (for details, see FIG. 12). A relay node is defined as a sensor node serving as a branch node or a leaf node in the tree.

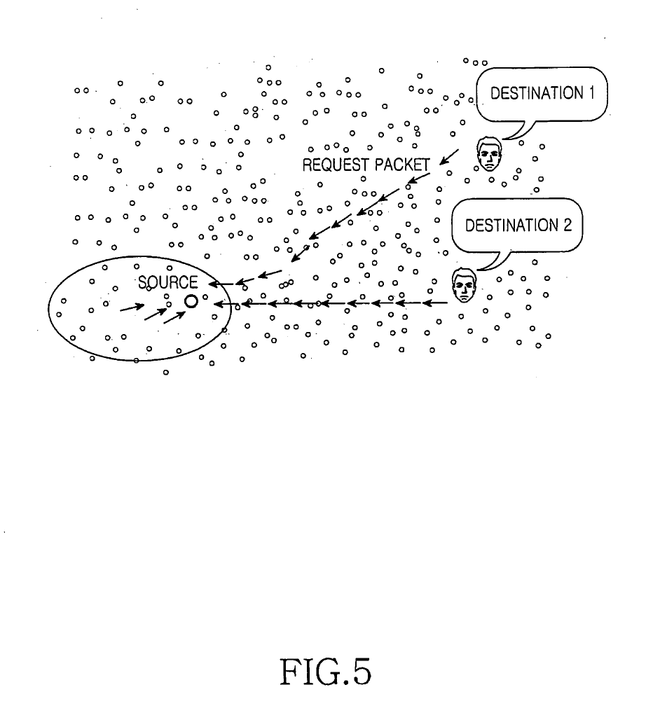

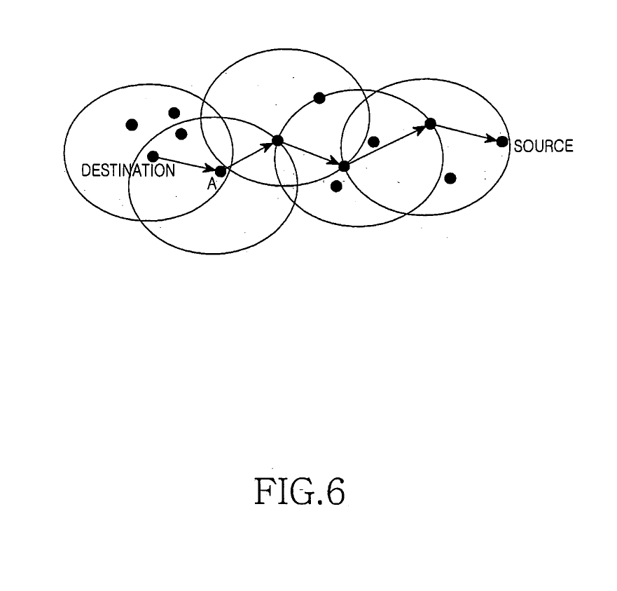

As illustrated in FIG. 5, a plurality of sinks (e.g. Sink 1 and Sink 2) send request packets to a source to transmit desired information. The request packets are routed in the direction of the source, relying on geographical locations, as illustrated in FIG. 6. Upon receipt of the request packets, sensor nodes forward the request packets to their neighbor sensor nodes closest to the source according to the locations of the neighbor sensor nodes.

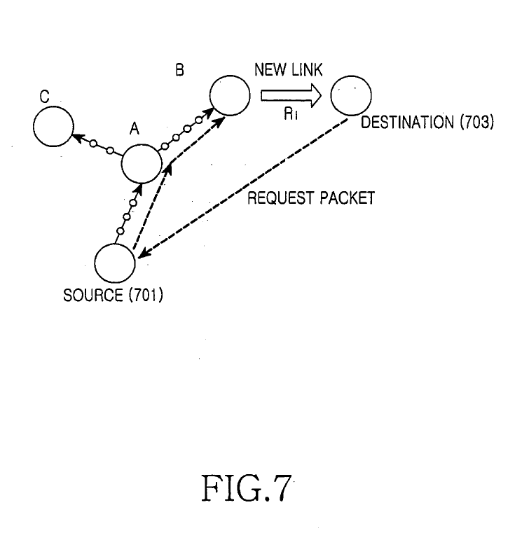

An operation for finding the most efficient relay node without reconfiguring an entire existing dissemination tree in order to add a new sink to the dissemination tree is illustrated in FIG. 7.

Referring to FIG. 7, upon receipt of a request packet from a new sink 703 by a predetermined routing scheme, a source 701 creates a token and sends the token along the dissemination tree, to thereby search for a relay node to which the sink 703 can be linked with the smallest delay cost in the dissemination tree. The delay cost which is a cost due to the geographical morphology including distance is calculated using the geographical locations of the relay node and the sink. Links among sensor nodes C, A, and B and the source 701 form the existing dissemination tree.

If the relay node A has the token from the source 701, the delay cost between the relay node A and the sink 703, the delay cost between a child node C for the relay node A and the sink 703, and the delay cost between another child node B for the relay node A and the sink 703 are compared. If the delay cost between the relay node A and the sink 703 is smallest, the relay node A is set as an entry relay node. However, if the delay cost between the child node C and the sink 703 is smallest, the relay node A forwards the token to the child node C and the above operation is repeated. The entry relay node is a relay mode that allows the sink to most efficiently join the existing dissemination tree without reconfiguration of the whole tree.

FIG. 8 is a flowchart illustrating a method of determining an entry relay node according to an embodiment of the present invention. Upon receipt of a request packet, a source determines whether it is possible to send sensed information to the sink that has sent the request packet by comparing the delay cost between the source and the sink with a maximum delay limit Qₘ as defined by Equation (1) below.
qd(r[i],aₘ)<Qₘ Equation (1)
where q is an average delay per unit distance (sec/m), r[i] is the source, aₘ is the sink, d(r[i], aₘ) is the distance between the source r[i] and the sink aₘ, and Qₘ is the maximum delay limit between the source r[i] and the sink aₘ.

If the condition described by Equation (1) is not fulfilled, that is, if the delay cost from the source to the sink, qd(r[i]aₘ) is equal to or greater than the maximum delay limit Qₘ, the source “rejects” sending the sensed information to the sink and notifies the sink of the transmission rejection. The sink resets Qₘ and retransmits the request packet to the source, or it gives up acquisition of the sensed information.

If the condition described in Equation (1) is fulfilled, that is, if the delay cost from the source to the sink, qd(r[i],aₘ) is less than the maximum delay limit Qₘ, the source creates a token by which to establish a path to the sink. The source then selects the next relay node and sends the token to the relay node in the procedure of FIG. 8.

A description will now be made of how the relay node receiving the token from the source determines an entry relay node. The token is routed to the relay node through neighbor sensor nodes based on the location of the relay node set in the token.

Referring to FIG. 8, a relay node monitors reception of the token including information about the location of a new sink to join the dissemination tree in step 801.

Upon receipt of the token, the relay node determines whether any child node h of the relay node exists from which a path to the sink can be established for data dissemination, by computing Equation (2) in step 803. A child node (e.g., h) is a relay node underlying the relay node having the token.
Sᵢ+q{d(r[i], h)+d(h,aₘ)}<Qₘ Equation (2)
where Sᵢ is the sum of delay costs from the source to the relay node along the tree, q is the average delay per unit distance (sec/m), r[i] is the relay node, h is the child node, d(r[i], h) is the distance between the relay node r[i] and the child node h, d(h, aₘ) is the distance between the child node h and the sink aₘ, and Qₘ is the maximum delay limit between the source and the sink. Sᵢ+q{d(r[i],h)+d(h,aₘ)} is the delay cost from the source to the sink aₘ through the relay node r[i] and the child node h. Thus, it is determined whether data dissemination to the sink through the child node is possible.

In the absence of any child node satisfying Equation (2), the relay node sets itself as an entry relay node in step 817.

However, in the presence of any child node satisfying Equation (2), the relay node groups such child nodes into a set H in step 805.

In step 807, the relay node selects a child node offering the smallest delay cost qd(h,aₘ) to the sink from the set H.

In step 809, the relay node compares its delay cost with the delay cost of the selected child node using Equation 3 below.
qd(h,aₘ)<qd(r[i],aₘ) Equation (3)
where qd(h,aₘ) is the delay cost from the selected child node h to the sink aₘ and qd(r[i],aₘ) is the delay cost from the current relay node r[i] having the token to the sink aₘ.

If Equation (3) is not satisfied, which implies that the delay cost of the selected child node is equal to or greater than that of the relay node, the relay node sets itself as an entry relay node in step 817 and then ends the algorithm.

On the contrary, if Equation (3) is satisfied, which implies that the delay cost of the selected child node is less than that of the relay node, the relay node decides the child node as the next relay node r[i+1] in step 811.

In step 813, the relay node calculates the sum of delay costs from the source to the next relay node r[i+1] to receive the token along the tree according to Equation (4):
Sᵢ₊₁=Sᵢ+qd(r[i],r[i+1]) Equation (4)
where Sᵢ₊₁ is the sum of delay costs from the source to the next relay node r[i+1] along the tree, Sᵢ is the sum of delay costs from the source to the relay node r[i] along the tree, and qd(r[i],r[i+1]) is the delay cost from the relay node r[i] to the next relay node r[i+1].

After Sᵢ₊₁ is computed, the relay node sends the token including Sᵢ₊₁ to the next relay node in step 815 and then ends the algorithm.

Once the entry relay node is determined in the procedure of FIG. 8, routing of the same sensed information from the entry relay node to a plurality of sinks can be considered in two ways. One of them is to connect the entry relay node directly to the sinks. The other is to establish an optimal path by selecting a sensor node which can route the sensed information with less energy consumption than direct routing by the entry relay node, if such a sensor node exists.

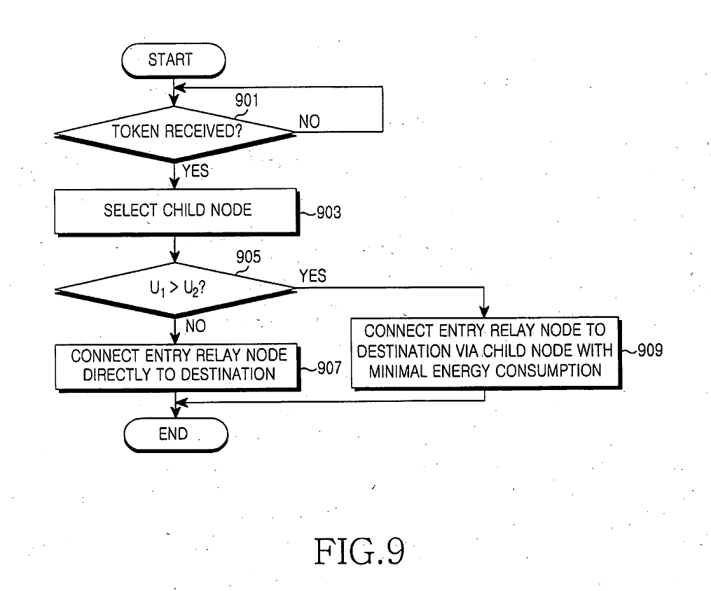

FIG. 9 is a flowchart illustrating a method of establishing paths to sinks after determining an entry relay node according to the present invention. As used herein, the following reference characters are used to denote the following. g: entry relay node; k: sensor node neighboring a current sensor node having a token; j: current sensor node having the token; c: child nodes for the entry relay node; and m: sink.

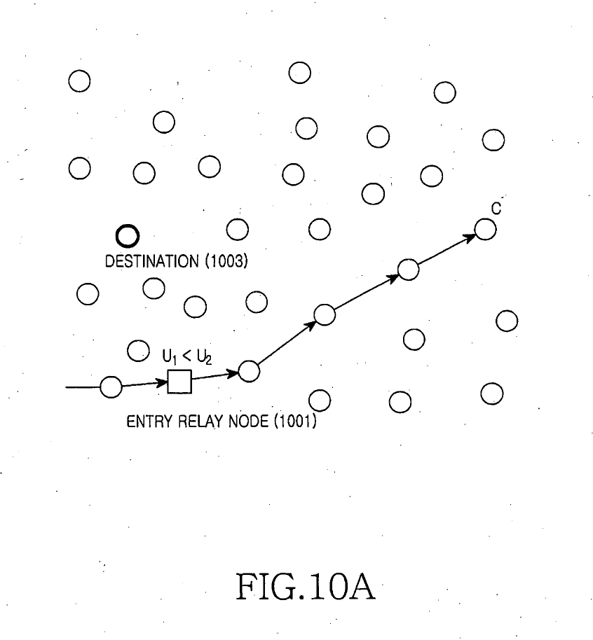

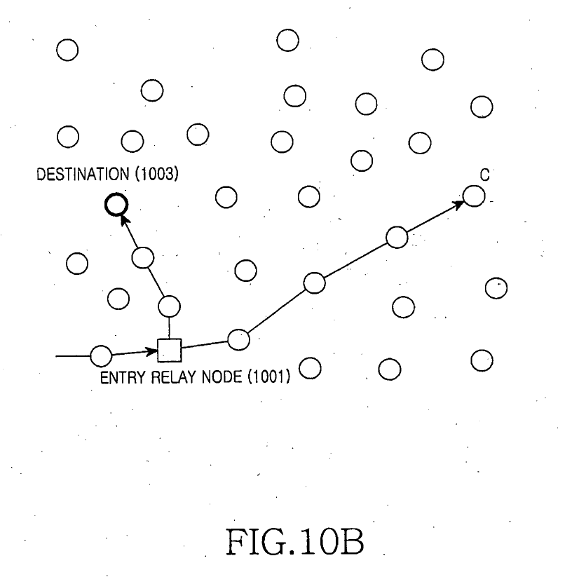

Referring to FIG. 9, the entry relay node determines whether the token has been received in step 901. Upon receipt of the token, the entry relay node selects a child node minimizing U₁ among its child nodes c using Equation (5), for establishing a path to the new sink as illustrated in FIG. 10A in step 903.

In step 905, the entry relay node determines whether to establish a direct path from the entry relay node to the sink or to establish a path from the entry relay node to the sink via a selected sensor node offering minimal energy consumption.

Energy consumption of a new path from the entry relay node to the sink via a neighbor sensor node k is compared with that of a direct path from the entry relay node to the sink using Equation 5:
U₁>U₂; where
U₁=d(g,m)+d(g,c); and
U₂=U(k,c)=d(g,k)+d(k,m)+d(k,c) Equation (5)
where d(g,m) is the energy cost from the entry relay node g to the sink m, d(g,c) is the energy cost from the entry relay node g to its child node c, d(g,k) is the energy cost from the entry relay node g to its neighbor sensor node k, d(k,m) is the energy cost from the neighbor sensor node k to the sink m, and d(k,c) is the energy cost from the neighbor sensor node k to the child node c. Therefore, U₁ is the energy cost of sending the sensed information to the sink in the direct path from the entry relay node, and U₂ is the energy cost of sending the sensed information to the sink in a new path from the entry relay node via the neighbor sensor node k.

In the absence of any neighbor sensor node satisfying the condition that U₁>U₂, the entry relay node connects itself directly to the sink and sends the sensed information in step 907. As illustrated in FIG. 10B, a direct path is established between an entry relay node 1001 and a sink (destination) 1003. The entry sensor node then ends the algorithm.

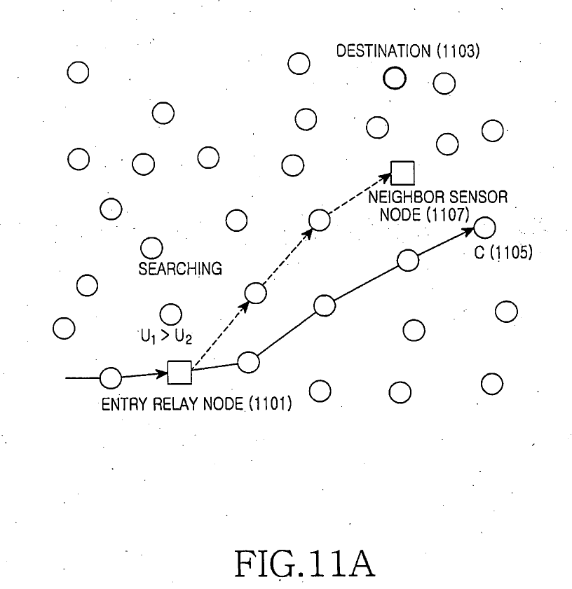

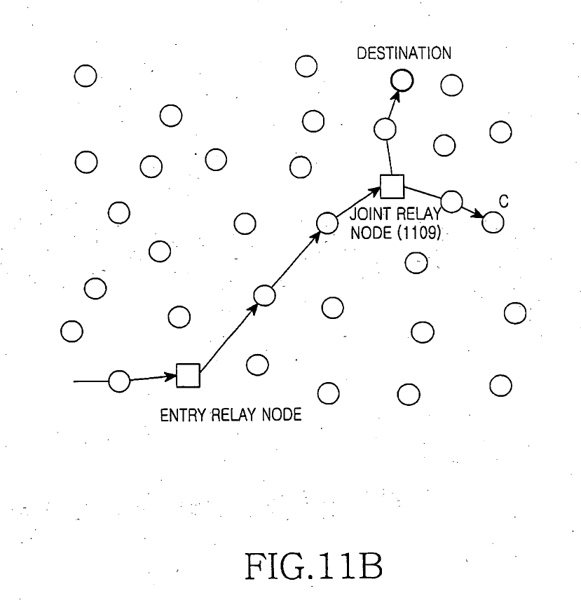

However, in the presence of any neighbor sensor node satisfying the condition that U₁>U₂, the entry relay node searches for a sensor node that enables data dissemination with minimal energy consumption (hereinafter, referred to a junction relay node) in step 909. The sensed information is sent to the sink in a new path passing through the junction relay node. In order to establish an optimal path using a sensor node offering minimal energy consumption, for instance, an entry relay node 1101 selects one of neighbor sensor nodes to route the same sensed information to a sink (i.e., a destination) 1103 and a child node 1105 (child node c), as illustrated in FIG. 11A. The energy consumption of paths leading from the entry relay node 1101 to the sink 1103 and to the child node 1105 via the selected neighbor sensor node 1107 is compared with that of paths leading from the entry relay node 1101 directly to the sink 1103 and directly to the child node 1105. By repeating this operation, a neighbor sensor node offering minimal power consumption is detected and set as a joint relay node 1109, as illustrated in FIG. 11B. Thus, routing the sensed information via the joint relay node 1109 reduces energy consumption.

The entry relay node then ends the algorithm for determining paths to a plurality of sinks.

FIG. 12 is a flowchart illustrating a method of determining a sensor node offering less energy consumption than an entry relay node after determining the entry relay node, in order to establish an optimal path according to the present invention.

Referring to FIG. 12, a sensor node monitors reception of a token in step 1201. The token is a message including information about the location of a new sink to set up a path in which sensed information is to be routed to the new sink (i.e., destination).

Upon receipt of the token, the sensor node determines whether any neighbor node can route the sensed information to the sink with reduced energy cost in step 1203.

In the absence of any neighbor sensor satisfying the condition that U₁>U₂ described by Equation (5), the sensor node sets itself as a joint relay node in step 1215.

In the presence of any neighbor sensor node satisfying the condition that U₁>U₂, the sensor node searches for neighbor sensor nodes satisfying Equation (6) and Equation (7) among those neighbor sensor nodes satisfying Equation (5) and groups them as one set J.

The routing delay of the sensed information to the sink is compared with a maximum energy limit using Equation (6) below.

$${S}_{g} + d ( g , k ) + d ( k , m ) \leq \frac{{Q}_{m}}{q} \qquad Equation ( 6 )$$

where S_{g} is the sum of energy costs from the source to the entry relay node g along the tree, d(g,k) is the energy cost from the entry relay node g to the neighbor sensor node k, d(k,m) is the energy cost from the neighbor sensor node k to the sink m, and Qₘ/q is the maximum energy limit between the source and the sink. q is an average delay per unit distance (sec/m). Using Equation (6), it is determined whether data dissemination from the source to the sink via the sensor node k is possible.

It is determined whether setup of the new path via the neighbor sensor node k satisfies the following condition defined in Equation (7) below.

$$d ( g , k ) + d ( k , c ) - d ( g , c ) \leq \frac{{w}_{c}}{q} \qquad Equation ( 7 )$$

where d(g,k)+d(k,c) is the energy cost of the candidate path from the entry relay node g to the child node c via the neighbor sensor node k, d(g,c) is the energy cost of the existing path from the entry relay node g to the child node c, and w_{c}/q is the difference between the maximum energy limit and the energy cost between the child node c and a sink connected to the child node c. q is an average delay per unit distance (sec/m) Therefore, the neighbor sensor node k is selected which satisfies the condition that an energy cost increase involved in setting up the new path is equal to or less than the energy limit of the child node c.

In step 1207, the sensor node selects a neighbor sensor node with the smallest energy cost from the set J.

The sensor node then compares the total energy cost of the candidate path passing through the selected neighbor sensor node k with the minimum energy cost in step 1209, in accordance with Equation (8):
U(k,c)<U(j,c); where
U(k,c)=d(g,k)+d(k,m)+d(k,c), and
U(j,c)=d(g,j)+d(j,m)+d(j,c), Equation (8)
where j is the sensor node currently having the token, d(g,k)+d(k,m)+d(k,c) is the total energy cost of the path from the entry relay node g to the sink m via the neighbor sensor node k and the path from the entry relay node g to the child node c via the neighbor sensor node k, and d(g,j)+d(j,m)+d(j,c) is the minimum energy cost, that is, the total energy cost of the path from the entry relay node g to the sink m via the sensor node j and the path form the entry relay node g to the child node c via the sensor node j. Thus, the total energy cost of the candidate path U(k,c) is compared with that of the current path U(j,c).

If the condition described by Equation (8) is not satisfied, the sensor node sets itself as a joint relay node in step 1215 and ends the algorithm.

If the condition described by Equation (8) is satisfied, the sensor node sets the neighbor sensor node k as the next neighbor sensor node to receive the token in step 1211 and sends the token to the neighbor sensor node k in step 1213. Then the algorithm ends.

As described above, in the case where a new sink requests the same sensed information as an existing sink, upon receipt of a request packet from the new sink, a source generates a token and searches for a relay node offering the smallest delay cost in data dissemination to the new sink among relay nodes linked in an existing tree. Then a neighbor sensor node offering minimal energy consumption in data dissemination to the sink is selected among the neighbor sensor nodes of the relay node, and is linked to the new sink.

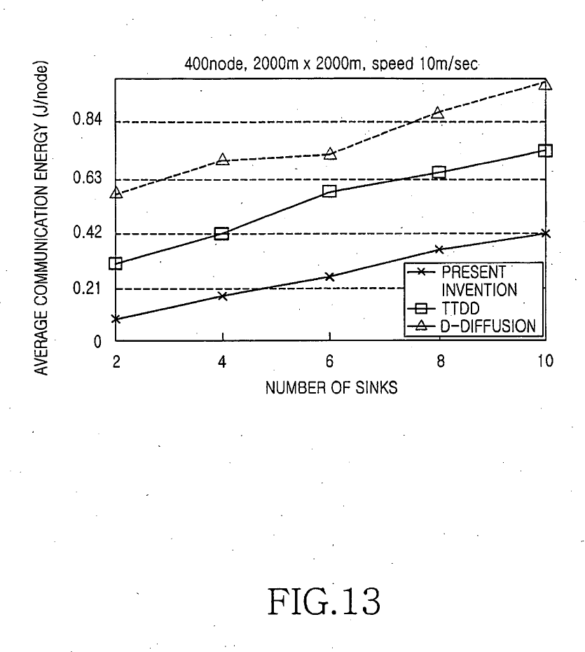

FIG. 13 is a graph illustrating improved performance of the present invention. Referring to FIG. 13, a horizontal axis represents the number of sinks requesting the same sensed information, and a vertical axis represents average energy consumption. The tree configuration of the present invention is compared with the conventional tree configuration schemes, TTDD and DD, in terms of energy consumption versus the number of sinks. As noted from the graph, the present invention provides the lowest energy consumption.

In accordance with the present invention as described above, since a new sink can be added to an existing dissemination tree without changing the whole tree structure, fast data dissemination is achieved even through sinks are freely added/pruned to/from the dissemination tree in a wireless sensor network. In addition, paths with minimal energy consumption are established for a plurality of sinks requesting the same sensed information. Therefore, the operating time of sensor nodes with limited battery power is prolonged, thereby increasing the nodes sensing duration and keeping paths for data dissemination uninterrupted for a long time. Also, the sensor nodes can be miniaturized, as suits the original purpose of the wireless sensor network and the battery capacity requirement can be reduced, saving cost.

Furthermore, since the path determination is made taking into account a delay limit as well as the distance between a source and a destination, Quality of Service (QoS) is also satisfied.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A method of configuring a tree when a new sink is added in a wireless sensor network, comprising the steps of:
selecting a first sensor node via which a path can run to the new sink with a smallest delay cost, if the new sink requesting the sensed information as a sink within an existing tree is added;
determining whether a path connecting the first sensor node directly to the new sink has minimal energy consumption, after selecting the first sensor node; and
selecting a second sensor node via which a path can run to the new sink with the minimal energy consumption, if the direct path does not have the minimal energy consumption,
whereby an optimal tree having the minimal energy consumption is configured.

2. The method of claim 1, wherein the first sensor node is one of sensor nodes serving as branch nodes or leaf nodes in the existing tree.

3. The method of claim 1, wherein the first sensor node selecting step comprises the steps of:
selecting a set of child nodes satisfying a predetermined condition, upon receipt of a message for tree connection;
selecting a child node via which a path can run to the new sink with the smallest delay cost from the set of child nodes;
comparing the delay cost from the selected child node to the new sink with the delay cost from the sensor node currently having the message for tree connection to the new sink; and
connecting the new sink to the sensor node receiving the message, if the delay cost from the selected child node to the new sink is equal to or greater than the delay cost from the sensor node currently having the message for tree connection to the new sink.

4. The method of claim 3, wherein the message for tree connection includes the address of the new sink and a sum of delay costs between a source sensor node which generated the sensed information to the sensor node currently having the message for tree connection.

5. The method of claim 3, wherein delay cost is calculated using a distance between sensor nodes to estimate delay between the sensor nodes.

6. The method of claim 3, wherein the predetermined condition is defined by
Sᵢ+q{d(r[i],h)+d(h,aₘ)}<Qₘ
wherein aₘ is the new sink, r[i] is the sensor node currently having the message for tree connection, Sᵢ is a sum of delay costs from the source sensor node to the sensor node r[i] along the tree, Qₘ is a maximum delay limit between the source sensor node and the new sink aₘ, q is an average delay per unit distance (sec/m), h is the selected child node, d(r[i], h) is the distance between the sensor node r[i] and the child node h, and. d(h, aₘ) is the distance between the child node h and the new sink aₘ.

7. The method of claim 3, further comprising:
calculating a sum of delay costs from the source sensor node to the selected child node, if the delay cost from the child node to the new sink is less than the delay cost from the sensor node currently having the message to the new sink;
updating the delay cost sum in the message for tree connection with the calculated delay cost sum; and
sending the updated message for tree connection to the child node.

8. The method of claim 7, wherein the delay cost sum is computed by
Sᵢ₊₁=Sᵢ+qd(r[i],r[i+1])
wherein r[i] is the sensor node currently having the message for tree connection, r[i+1] is the selected child node, Sᵢ is a sum of delay costs from the source sensor node to the sensor node r[i] along the tree, Sᵢ₊₁ is the sum of delay costs from the source sensor node to the selected child node r[i+1] along the tree, and qd(r[i],r[i+1]) is a delay cost from the sensor node r[i] to the selected child node r[i+1].

9. The method of claim 1, wherein the step of determining whether a path connecting the first sensor node directly to the new sink has minimal energy consumption is determined by
U₁>U₂, where U₁=d(g,m)+d(g,c),U₂=U(k,c)=d(g,k)+d(k,m)+d(k,c), and
g is the first sensor node, m is the new sink, c is a child node of the first sensor node, k is any neighbor sensor node of the first sensor node g, d(g,m)+d(g,c) is a sum of the distance from the first sensor node g to the new sink m and a distance from the first sensor node g to the child node c, and d(g,k)+d(k,m)+d(k,c) is a sum of the distance from the first sensor node g to the child node c via the neighbor sensor node k and a distance from the first sensor node g to the child node c via the neighbor sensor node k.

10. The method of claim 9, further comprising determining the path connecting the first sensor node directly to the new sink is an optimal path, if U₁ is less that or equal to U₂ is not satisfied.

11. The method of claim 1, wherein the second sensor node selecting step comprises the steps of:
selecting a set of neighbor sensor nodes satisfying a predetermined condition, upon receipt of a message for tree connection;
selecting a neighbor sensor node via which a path can run to the new sink and to an existing sink connected to the first sensor node with the smallest delay cost from the set of neighbor sensor nodes;
comparing the energy cost of the selected neighbor sensor node with the energy cost of paths between the sensor node receiving the message for tree connection and the new sink and between the sensor node receiving the message for tree connection and the existing sink; and
selecting the sensor node receiving the message for tree connection as the second sensor node if the energy cost of the sensor node receiving the message for tree connection is less than the energy cost of the selected neighbor sensor node.

12. The method of claim 11, wherein the predetermined condition is satisfied if the sensed information can be routed from the source sensor node to the new sink via the neighbor sensor node, and a new path is available from the first sensor node to the existing sink via the neighbor sensor node.

13. The method of claim 12, wherein it is determined whether the sensed information can be routed from the source sensor node to the new sink via the neighbor sensor node by
$${S}_{g} + d ( g , k ) + d ( k , m ) \leq \frac{{Q}_{m}}{q} [ ri ]$$
where S_{g} is a sum of energy costs from the source sensor node to the first sensor node g along the tree, d(g,k)+d(k,m) is the energy cost from the first sensor node g to the new sink m via the neighbor sensor node k, and
$$\frac{{Q}_{m}}{q}$$
is a maximum energy limit between the source sensor node and the new sink m, q is an average delay per unit distance (sec/m).

14. The method of claim 12, wherein it is determined whether a new path is available from the first sensor node to the existing sink via the neighbor sensor node by
$$d ( g , k ) + d ( k , c ) - d ( g , c ) \leq \frac{{w}_{c}}{q} ,$$
where d(g,k)+d(k,c) is the energy cost from the first sensor node g to a child node c of the first sensor node via the neighbor sensor node k, d(g,c) is the energy cost from the first sensor node g to the child node c, and
$$\frac{{w}_{c}}{q}$$
is the difference between a maximum energy limit and the energy cost from the child node c to a sink connected to the child node c, q is an average delay per unit distance (sec/m)

15. The method of claim 11, wherein the energy cost of the selected neighbor sensor node is computed by
U₂=U(k,c)=d(g,k)+d(k,m)+d(k,c),
where g is the first sensor node, k is the selected neighbor sensor node, m is the new sink, c is a child of the first sensor node, U₂ is the energy cost of the selected neighbor sensor node, d(g,k) is an energy cost from the first sensor node g to the neighbor sensor node k, d(k,m) is an energy cost from the neighbor sensor node k to the new sink m, and d(k,c) is an energy cost from the neighbor sensor node k to the child node c.

16. The method of claim 11, further comprising setting the selected neighbor sensor node as a sensor node to receive the message and sending the message to the selected neighbor sensor node, if the energy cost of the selected neighbor sensor node is less than the energy cost of the sensor node receiving the message.

17. The method of claim 11, wherein the message for tree connection includes an address of the new sink.

18. The method of claim 1, further comprising connecting the new sink directly to the first sensor node, if the direct path has the minimal energy consumption.
